(19) United States
(12) Patent Application Publication
(10) Pub. No.: US 2010/0207428 A1
(43) Pub. Date: Aug. 19, 2010

(54) SIDE VEHICLE-BODY STRUCTURE OF AUTOMOTIVE VEHICLE

(75) Inventor: Yoshio FUKUSHIMA, Hiroshima (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/692,169

(22) Filed: Jan. 22, 2010

(30) Foreign Application Priority Data
Feb. 16, 2009 (JP) 2009-032478
Feb. 17, 2009 (JP) 2009-033824

(51) Int. Cl. B62D 25/02

(52) U.S. Cl. 296/203.03

(57) ABSTRACT

A second closed cross section which projects toward the outside from a third lower flange of a side sill outer and a lower end portion is provided. Lower cross sections of the third lower flange and the lower end portion contact a second upper wall portion. The second closed cross section and a third closed cross section are formed by a side sill reinforcement of a frame member of a vehicle body. Thereby, a split line can be made be recognized as on body with the second closed cross section, so that both increasing the vehicle-body rigidity and improving the exterior appearance can be achieved.

### BACKGROUND OF THE INVENTION

The present invention relates to a side vehicle-body structure of an automotive vehicle, and in particular, relates to a structure of a side sill which is connected to a side body outer panel forming a surface of a lower vehicle body.

Conventionally, the side sill which extends in the vehicle longitudinal direction is provided below a side face of the vehicle body in the automotive vehicle. This side sill is formed in a structure having a closed cross section, which is comprised of a side sill inner which is arranged on the inside and a side sill outer which is arranged on the outside in the vehicle width direction, aiming at the reduction of vehicle-body weight to ensure the sufficient rigidity of the lower vehicle body.

Meanwhile, a structure which improves an exterior appearance of the side face of the vehicle body with a properly large volume of the lower vehicle body is recently known. Although a structure in which the side sill outer covering the outside of the vehicle body protrudes greatly toward the outside in the vehicle width direction may be considered as possibility of improving the above-described exterior appearance, there may be the flowing problems in this regard.

First, in case the side sill outer has a protrusion portion which protrudes greatly toward the outside, steel-plate portions increase greatly, so that the weight of the vehicle body may increase. This weight increase may cause the cost up as well. Secondly, there is a problem in forming the vehicle body. In the conventional so-called monocoque-body, the side body outer panel which forms the surface around an opening of a side door extends downwardly in the vehicle vertical direction so as to integrally form the side sill outer. Thereby, the side body outer panel and the side sill inner panel are formed at the same time in forming through pressing.

In case of conducting the pressing, an edge area of the member (works) has an inferior processing, compared to a central area of the member (works), from viewpoints of fluidity of the steel-plate material. This inferiority becomes noticeable as the processing area is larger or the processing amount is greater like the vehicle-body surface. Accordingly, in case the protruding portion is formed at the edge area of the large member, such as the side body outer panel, some problem such as cracking may occur in the processing.

Herein, a structure in which a side sill garnish covering the outside is attached to the side sill so as to enlarge the exterior-appearance volume of the lower vehicle body for improving the exterior appearance and design is known as one of solutions of the above-described problem (see Japanese Patent Laid-Open Publication No. 2007-261480).

The above-described publication discloses the structure of a side sill 100 comprising a side sill inner 101, a side sill outer 102, and a side sill reinforcement 103 which is provided between the both members 101, 102 to reinforce the side sill 100, in which a closed cross section is formed by the side sill inner 101 and the side sill reinforcement 103, as shown in FIG. 13. Further, this publication proposes a side sill garnish 104 which extends in the vehicle longitudinal direction on the side sill 100 so as to cover the outside and the lower side of the side sill 100, wherein the side sill garnish 104 includes a projection portion which comprises a side face portion 105 covering the side face of the side sill 100, a lower face portion 106 covering the lower face of the side sill 100, and a concave portion for a jack 107.

According to the structure of the above-described publication, the exterior appearance may be improved without using any vehicle-body rigidity member. Moreover, it may be restrained that any improper articles, such as sands, come into a space between the side sill and the side sill garnish and drift therein, without any interference between the jack and the side sill garnish. Further, the protrusion of the vehicle-body lower portion toward the outside in the vehicle width direction may improve the resistance of chipping caused by sands, stones or the like during a vehicle traveling, and aerodynamic characteristics by reducing the amount of traveling winds flowing into a wheel house.

However, while it may be possible that the lower portion of the side sill outer is made short so as to be positioned at a relatively upper portion of the vehicle body, the flexibility of designing may not be improved properly by the structure of the above-described publication. That is, a boundary portion between a lower end of a joint face portion of the side sill outer and the side sill reinforcement, i.e., a split line between them, is hidden. Accordingly, it may be necessary that the split line is arranged on the inside of the side sill garnish by extending the lower end of the joint face portion of the side sill outer downwardly, or by extending the projection portion of the side sill garnish upwardly, so that the flexibility of designing may be restricted.

Further, in case of arranging the side sill garnish, a new designing of the side sill garnish and an additional assembling step are necessary, so that there may occur another cost problem than material costs. Additionally, while the side sill garnish may improve the exterior appearance, it may not contribute to improving the vehicle-body rigidity properly.

### SUMMARY OF THE INVENTION

An object of the present invention is to provide a side vehicle-body structure of an automotive vehicle which can improve the exterior appearance of the boundary portion of the lower end of the side sill outer, ensuring the designing flexibility by arranging the side sill outer at the upper portion of the vehicle body.

According to the present invention, there is a side vehicle-body structure of an automotive vehicle, comprising a side body outer panel forming a surface of a vehicle-body side portion, and a side sill extending in a vehicle longitudinal direction and connected to the side body outer panel, wherein the side sill includes a side sill outer which is provided at a lower portion of the side body outer panel, a side sill inner which is provided on the inside of the side sill outer in a vehicle width direction, a plate-shaped reinforcement member which is provided between the side sill inner and the side sill outer and joined to a joint face portion of the side sill outer, and a projection portion which projects toward the outside in the vehicle width direction from the joint face portion, and an upper wall portion of the projection portion is arranged substantially at the same level as a lower end of the joint face portion.

According to the present invention, the exterior appearance of the boundary portion of the lower end of the side sill outer can be improved ensuring the designing flexibility by arranging the side sill outer at the upper portion of the vehicle body. That is, since the upper wall portion of the projection portion is arranged substantially at the same level as the lower end of the joint face portion of the side sill outer, the users may be made recognize the boundary portion and the projection portion as one body. Thereby, the split line of the side sill outer can be made properly unnoticeable, so that the exterior appearance can be improved without extending the lower end of the joint face portion of the side sill outer downward, or extending the projection portion of the side sill garnish upward. Further, even if the projection portion is formed by the frame member of the vehicle body aiming at increasing the vehicle-body rigidity, the boundary portion can be made be recognized by the users as one body with the projecting portion of the vehicle-body member, so that improving both the vehicle-body rigidity and the exterior appearance can be achieved.

According to an embodiment of the present invention, a side door which opens or closes an opening formed at the side body outer panel is provided, and the lower end of the joint face portion of the side sill outer and a lower end portion of the side door are arranged substantially at the same level. Thereby, since the lower end of the joint face portion of the side sill outer and the lower end portion of the side door are arranged substantially at the same level, the joint face portion of the side sill outer can be hidden by the side door when the side door is in its closing state. When the side door is in its open state, the users can be made recognize the boundary portion and the projection portion as one body. Accordingly, the exterior appearance can be further improved.

According to another embodiment of the present invention, the side door has a seal member which seals a space between the side door and the side sill when the side door closes, and the side sill outer includes a seal face portion which an upper portion of the seal member contacts. Thereby, even in case the joint face portion of the side sill outer is arranged at the upper portion of the vehicle body which is close to the position of the lower end of the side door, both improving the exterior appearance and ensuring the proper door sealing can be achieved.

According to another embodiment of the present invention, the side body outer panel includes a wheel house portion which stores a rear wheel at a rear portion thereof and a wheel-house arch portion which forms a substantially continuous surface with the closing side door between the wheel house portion and the side door, and a lower end portion of the wheel-house arch portion is arranged substantially at the same level as the lower end of the joint face portion. Thereby, since the lower end portion of the wheel-house arch portion is arranged substantially at the same level as the lower end of the joint face portion, the lower end portion of the wheel-house arch portion and the lower end of the joint face portion, i.e., the upper wall portion of the projection portion, can be made continuous with the parting line of the side door, thereby further improving the exterior appearance.

According to another embodiment of the present invention, a garnish is provided so as to cover the lower end portion of the wheel-house arch portion and the upper wall portion of the projection portion in an area adjacent to the wheel-house arch portion. Thereby, the joint face portion of the side sill outer and the split line can be covered with the garnish regardless of the design of the wheel-house arch portion, so that the exterior appearance can be improved.

According to another embodiment of the present invention, the projection portion projects toward the outside from an outside boundary face of the rear wheel. Thereby, the improvements of the resistance of chipping caused by sands, stones or the like during the vehicle traveling and the aerodynamic characteristics by reducing the amount of traveling winds flowing into a wheel house can be achieved.

According to another embodiment of the present invention, the projection portion is formed at the plate-shaped reinforcement member and comprised of a protrusion portion which protrudes toward the outside in the vehicle width direction from the joint face portion. Thereby, the improvement of the exterior appearance can be achieved properly with the increase of the vehicle-body rigidity by increasing the closed cross section of the side sill without using the side sill garnish.

According to another embodiment of the present invention, the protrusion portion protrudes toward the outside in the vehicle width direction from the lower end of the side door when the side door closes. Thereby, sands, stones or the like can be surely prevented from scattering to the lower end of the side door.

According to another embodiment of the present invention, the side sill comprises a flange which comprises a lower end portion of the side sill inner and a lower end portion of the plate-shaped reinforcement member, and the protrusion portion comprises a step portion which projects downwardly beyond the flange. Thereby, the flange can be hidden from the vehicle outside, without providing any additional member or changing the shape of the side sill inner.

According to another embodiment of the present invention, the protrusion portion comprises a flat plate portion which extends downwardly on the outside. Thereby, the shape of the side sill can be set properly regardless of the shape or processing conditions of the side body outer panel, thereby improving the designing flexibility.

According to another embodiment of the present invention, the side body outer panel includes a wheel house portion which stores a rear wheel at a rear portion thereof and a wheel-house arch portion which forms a substantially continuous surface with the closing side door between the wheel house portion and the side door, a garnish is provided so as to cover a lower end portion of the wheel-house arch portion and the upper wall portion of the projection portion in an area adjacent to the wheel-house arch portion, and the garnish comprises a garnish face portion which is substantially flush with a surface of the wheel-house arch portion and the flat plate portion of the protrusion portion. Thereby, the design of the vehicle-body side face can be improved.

According to another embodiment of the present invention, the projection portion is comprised of a side sill garnish which is attached to an outside face of the side sill. Thereby, the projection portion can be easily formed by the side sill garnish.

According to another embodiment of the present invention, the side sill outer is formed integrally with the side body outer panel. Thereby, the processing of the vehicle body can be easier.

Other features, aspects, and advantages of the present invention will become apparent from the following description which refers to the accompanying drawings.

### BRIEF DESCRIPTION OF THE DRAWINGS

FIG. 1 is a side view showing a side vehicle-body structure of an automotive vehicle according to a first embodiment of the present invention.

FIG. 2 is a side view showing the side vehicle-body structure in a state in which a side door is removed according to the first embodiment.

FIG. 3 is an exploded perspective view of the side vehicle-body structure shown in FIG. 2.

FIG. 4 is a perspective view of a major part of the side vehicle-body structure according to the first embodiment.

FIG. 5 is a sectional view taken along line V-V of FIG. 2.

FIG. 6 is a sectional view taken along line VI-VI of FIG. 2.

FIG. 7 is a sectional view taken along line VII-VII of FIG. 2.

FIG. 8 is a sectional view taken along line VIII-VIII of FIG. 2.

FIG. 9 is a perspective view of a major part of a side vehicle-body structure according to a second embodiment.

FIG. 10 is a sectional view of the second embodiment, which corresponds to FIG. 7.

FIG. 11 is a sectional view of a garnish attaching portion of the second embodiment.

FIG. 12 is a sectional view of a third embodiment, which corresponds to FIG. 6.

FIG. 13 is an explanatory diagram of prior art.

### DETAILED DESCRIPTION OF THE INVENTION

Hereinafter, preferred embodiments of the present invention will be described.

### Embodiment 1

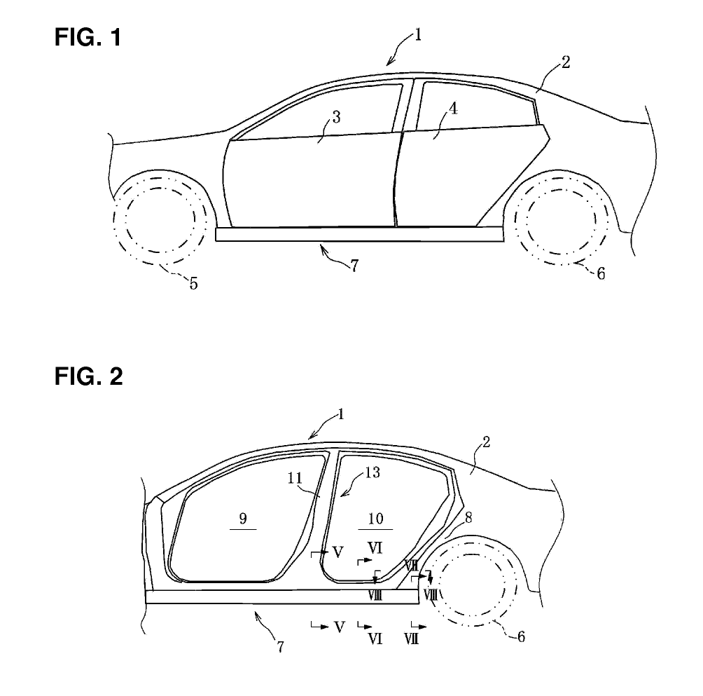

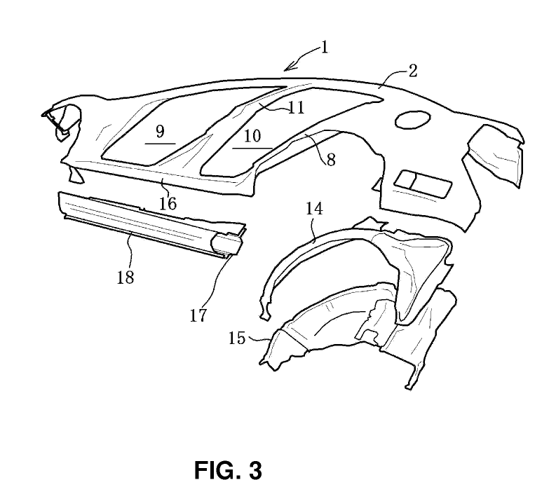

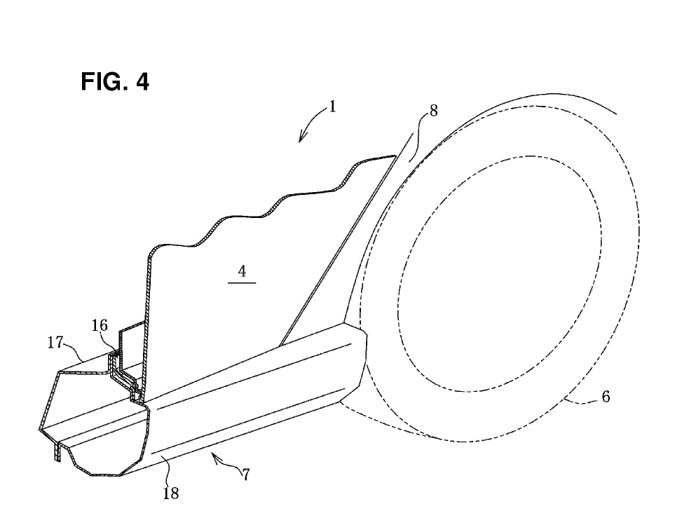

A first embodiment of the present invention will be described referring to the accompanying drawings. FIG. 1 is a side view showing a side vehicle-body structure of an automotive vehicle according to the first embodiment of the present invention. FIG. 2 is a side view showing the side vehicle-body structure in a state in which a side door is removed according to the first embodiment. FIG. 3 is an exploded perspective view of the side vehicle-body structure shown in FIG. 2. FIG. 4 is a perspective view of a major part of the side vehicle-body structure according to the first embodiment.

As shown in FIG. 1, a vehicle 1 according to the first embodiment, which is a four door type of passenger vehicle, comprises pairs of side frame outers 2 (side body outer panel), front doors 3, rear doors 4, front wheels 5, and rear wheels 6. A side sill 7 which is connected to the side frame outer 2 and extends in a vehicle longitudinal direction as a frame member of the vehicle 1 is arranged below the front door 3 and the rear door 4.

As shown in FIG. 2, the side frame outer 2 comprises a wheel-house arch portion 8 which is formed in a rear area thereof so as to surround the rear wheel, and a wheel house portion which is formed by a wheel house outer 14 and a wheel house inner 15, which will be described below.

The side frame outer 2 further comprises a front opening 9 for passenger's ingress and egress, to which the front door 3 is pivotally joined, a rear opening 10, to which the rear door 4 is pivotally joined, and a center pillar outer 11 which is formed between the front opening 9 and the rear opening 10 so as to vertically interconnect an upper end portion and a lower end portion of the side frame outer 2. Herein, the side frame outer 2 is formed through pressing after blanking of a steel plate having a specified thickness, for example, 0.7 mm

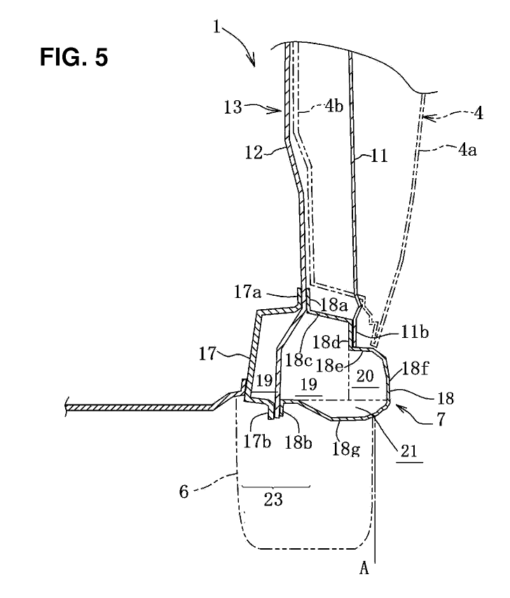

Further, the center pillar outer 11 forms a center pillar 13 having a closed cross section together with a center pillar inner 12 (see FIG. 5). An upper end portion of the center pillar 13 is connected to a roof side rail having a closed cross section, and a lower end portion of which is connected to the side sill 7.

As shown in FIGS. 3 and 4, the wheel house outer 14 which is positioned on the outside and the wheel house inner 15 which is positioned on the inside are arranged inside the wheel-house arch portion 8. The wheel house outer 14 and the wheel house inner 15 are joined at their both ends and upper ends so as to form a space for storing the rear wheel 6 at their central area.

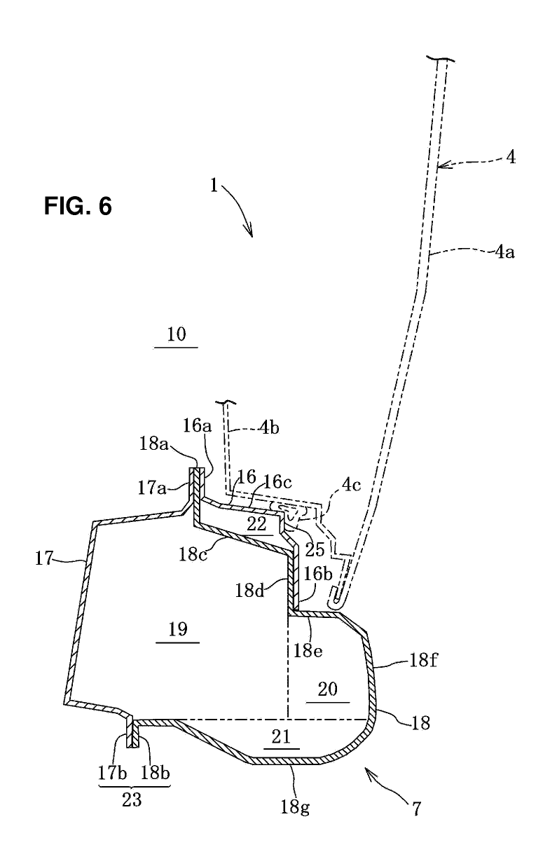

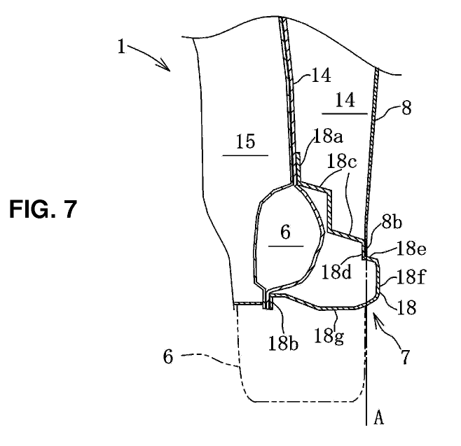

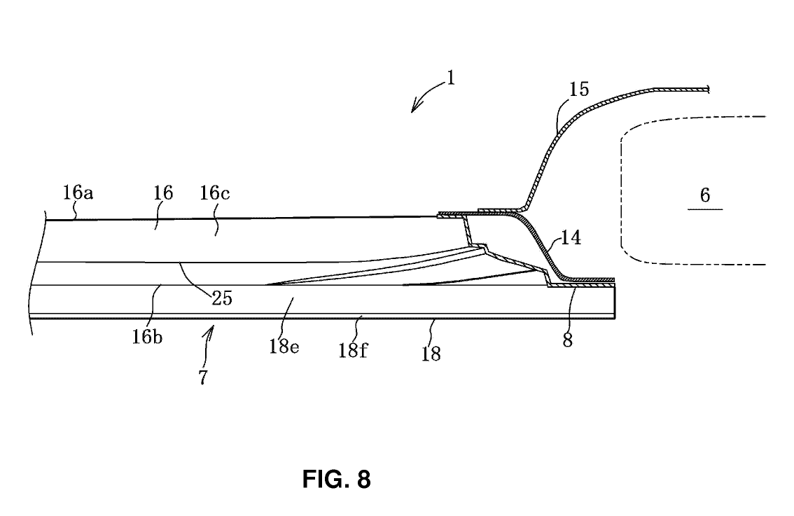

Next, the structure of the side sill 7 will be described referring to FIGS. 5-8. FIG. 5 is a sectional view taken along line V-V of FIG. 2. FIG. 6 is a sectional view taken along line VI-VI of FIG. 2. FIG. 7 is a sectional view taken along line VII-VII of FIG. 2. FIG. 8 is a sectional view taken along line VIII-VIII of FIG. 2.

The side sill 7 which is connected to the side frame outer 2 comprises a side sill outer 16 which is formed by the lower portion of side frame outer 2, a side sill inner 7 which is positioned inside the side sill outer 16, and a side sill reinforcement 18 (plate-shaped shaped reinforcement member). The side sill reinforcement 18 is formed through pressing after blanking of a steel plate having a specified thickness, for example, 1.4 mm Herein, the central portion of the side frame outer 2 forms the center pillar outer 11, and the lower portion of the side frame outer 2 forms the side sill outer 16.

The hat-shaped side sill reinforcement 18 is arranged between the inside hat-shaped side sill inner 17 and the outside side sill outer 16, and a first upper flange 17a and a first lower flange 17b of the side sill inner 17 are welded to a second upper flange 18a and a second lower flange 18b of the side sill reinforcement 18, respectively. At the lower end of the side sill 7 is formed a flange 23 which is comprised of the first lower flange 17b of the side sill inner 17 and the second lower flange 18b of the side sill reinforcement 18.

The cross section of the side sill reinforcement 18 is comprised of a first upper wall portion 18c which extends toward the outside continuously from a lower end of the second upper flange 18a, a flat-shaped joint portion 18d which extends downwardly continuously from an outside end of the first upper wall portion 18c, a second upper wall portion 18e which bends toward the outside from a lower end of the joint portion 18d and extends substantially horizontally, a flat plate portion 18f which extends downwardly continuously from an outside end of the second upper wall portion 18e, and a step portion 18g which projects downwardly from a lower end of the flat plate portion 18f beyond a lower end of the second lower flange 18b and then curves upwardly and connects to an upper end of the second lower flange 18b. Herein, the first upper wall portion 18c, the joint portion 18d, the second upper wall portion 18e, the flat plate portion 18f, and the step portion 18g form respective faces which extend in the vehicle longitudinal direction.

The side sill reinforcement 18 and the side sill inner 17 extend in the vehicle longitudinal direction and form the closed cross section. This closed cross section is comprised of a first closed cross section 19 which is defined by the side sill inner 17, the first upper wall portion 18c, the joint portion 18d, and the second lower flange 18b, a second closed cross section 20 which is positioned outside the first closed cross section 19 and defined by the second upper wall portion 18e and the flat plate portion 18f, and a third closed cross section 21 which is positioned below the first and second closed cross sections 19, 20 and defined by the step portion 18g. The second closed cross section 20 projects toward the outside beyond a boundary A of the outside face of the rear wheel 6. Herein, the second closed cross section 20 substantially corresponds to a protrusion potion of the present invention.

As shown in FIG. 5, the center pillar inner 12 extends downwardly to the welding joint portion of the first lower flange 17b and the second lower flange 18b in an area in which the center pillar 13 is provided. That is, the side sill reinforcement 18 and the side sill inner 17 are provided on the both sides of the center pillar inner such that three members of the first upper flange 17a, the center pillar inner 12, and the second upper flange 18a are joined together and three members of the first lower flange 17b, the center pillar inner 12, and the second lower flange 18b are joined together. Thereby, the first closed cross section 19 is divided into two areas of an outside area and an inside area by the center pillar 12 in an area of the center pillar 13.

A lower end portion 11b of the center pillar outer 11 extends downwardly to the lower end of the flat-shaped joint portion 18d, and a lower cross section of the lower end portion 11b contacts the second upper wall portion 18e. The inside face of the lower end portion 11b of the center pillar outer 11 is welded to the outside face of the joint portion 18d. Thus, the first upper wall portion 18c forms a node which separates the inside of the center pillar 13 into two areas in the vertical direction of the vehicle body.

As shown in FIG. 6, a rear opening 10 is formed behind the center pillar 13. Three members of the first upper flange 17a, the second upper flange 18a, and a third upper flange 16a which forms an edge of the rear opening 10 above a third lower flange 16b of the side sill outer 16 are welded together.

A projection portion 16c which extends toward the outside continuously from the lower end of the third upper flange 16a is arranged facing to the first upper wall portion 18c and forms a fourth closed cross section 22 together with the first upper wall portion 18c. The third lower flange 16b extends downwardly from the outside end of the projection portion 16c. Herein, the third lower flange 16b and the lower end portion 11b extend continuously in the vehicle longitudinal direction, which substantially correspond to a joint face portion of the present invention.

The third lower flange 16b extends downwardly to the lower end of the flat-shaped shaped joint portion 18d, and the lower cross section of the third lower flange 16b contacts the second upper wall portion 18e. The inside face of the third lower flange 16b contacts and is welded to the outside face of the joint portion 18d. Thereby, the lower cross section of the third lower flange 16b, i.e., the split line can be made be recognized as one body with a starting point of the second closed cross section 20, i.e., a bending curve line.

Further, the lower end of the rear door 4 which is comprised of a rear door outer 4a and a rear door inner 4b is positioned so as to face to the lower end of the joint portion 18d, i.e., the outside end portion of the second upper wall portion 18e, so that it is positioned substantially at the same level as the lower cross section of the lower end portion 11b of the center pillar outer 11, i.e., the lower cross section of the third lower flange 16b of the side sill outer 16. Thereby, when the rear door 4 is closed, the protrusion portion comprised of the second closed cross section 20 and part of the third closed cross section 21 is arranged (exists) between the lower end of the rear door 4 and the ground.

A seal member 4c which protects the vehicle inside from the water and the like is attached to the lower end face of the rear door inner 4b. When the rear door 4 is closed, this seal member 4c contacts a seal face portion 25 which is formed at the outside end portion of the projection portion 16c so as to ensure sealing.

As shown in FIGS. 7 and 8, the side sill outer 16 and the side sill reinforcement 18 extend rearwardly in an area of the vehicle rear portion. The rear end area of the side sill reinforcement 18 contacts the wheel-house arch portion 8. The second upper flange 18a and the second lower flange 18b contact the outside face of the wheel house outer 14, respectively, and these members and the wheel house inner 15 are joined together.

As shown in FIG. 8, the side sill outer 16, the seal portion 25, the second upper wall portion 18e, and the flat plate portion 18f are recognized in the plan view. A front lower end portion 8b of the wheel-house arch portion 8 is arranged, like the third lower flange 16b of the side sill outer 16, so as to contract the second upper wall portion 18e of the side sill reinforcement 18 and to be welded to the outside face of the joint portion 18d. Thus, the lower cross section of the lower end portion 8b is configured to be continuous with the parting line of the rear door 4.

The second upper wall portion 18c has a two-stage structure with an upper wall and a lower wall so as to enlarge its contact area with the wheel-house arch portion 8. The second closed cross section 20, which is defined by the second upper wall portion 18e and the flat plate portion 18f, in an area of the vehicle front portion in front of the wheel-house arch portion 8 projects toward the outside beyond the boundary A of the outside face of the rear wheel 6, when viewed from the front of the vehicle 1.

Hereinafter, the operations and advantages of the side vehicle-body structure according to the first embodiment will be described.

Since the second closed cross section 20 which projects toward the outside beyond the third lower flange 16b of the side sill outer 16 and the lower end portion 11b is provided, and the lower cross sections of the third lower flange 16b and the lower end portion 11b, i.e., the split line contacts the second upper wall portion 18e which forms the second closed cross section 20, the split line of the side sill outer 16 can be made properly unnoticeable, so that the exterior appearance can be improved.

Further, since the side sill outer 16 is arranged at the upper portion of the vehicle body, the protruding portion can be formed by the side sill reinforcement 18, not by the side sill outer 16, the designing flexibility of the protrusion portion can be improved.

Further, since the second closed cross section 20 and the third closed cross section 21 are formed by the side sill reinforcement 18 of the frame member of the vehicle body, the split line can be made be recognized as one body with the second closed cross section 20, so that improving both the vehicle-body rigidity and the exterior appearance can be achieved.

Since the lower cross sections of the third lower flange 16b and the lower end portion 11b and the lower end portion of the side door 4 are arranged substantially at the same level, when the rear door 4 is in its closed state, the joint face portion of the side sill outer 16 can be hidden by the rear door 4, and when the side door 4 is in its open state, the users can be made recognize the split line and the second closed cross section 20 as one body.

Moreover, since the second closed cross section 20 is formed at the side sill reinforcement member 18 and protrudes toward the outside in the vehicle width direction from the third lower flange 16b and the lower end portion 11b, the vehicle-body rigidity can be improved by increasing the area of the closed cross section of the side sill 7 without using the side sill garnish or other members, and the resistance of chipping during the vehicle traveling and the aerodynamic characteristics can be improved.

Since the side sill outer 16 includes the seal face portion 25, the upper portion of which the seal member 4c contacts, even in case the third lower flange 16b is arranged at the upper portion of the vehicle body which is close to the position of the lower end of the rear door 4, both improving the exterior appearance and ensuring the proper door sealing can be achieved.

Since the lower end portion 8b of the wheel-house arch portion 8 is arranged substantially at the same level as the lower cross sections of the third lower flange 16b and the lower end portion 11b, the lower end portion 8b of the wheel-house arch portion 8 and the second upper wall portion 18e which forms the second closed cross section 20 can be made continuous with the parting line of the rear door 4, thereby further improving the exterior appearance.

### Embodiment 2

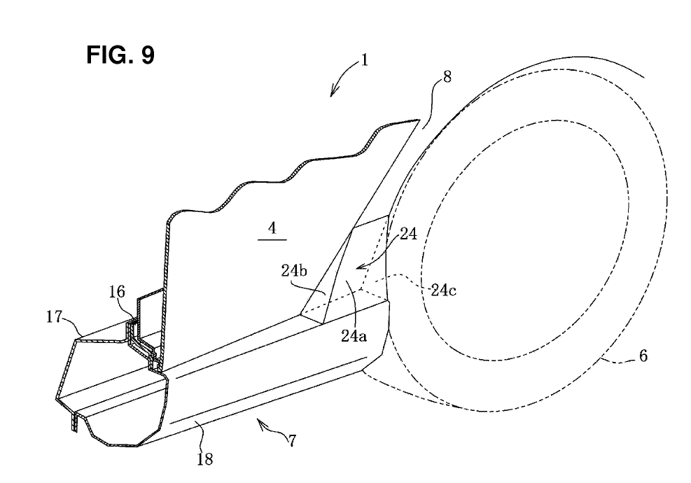

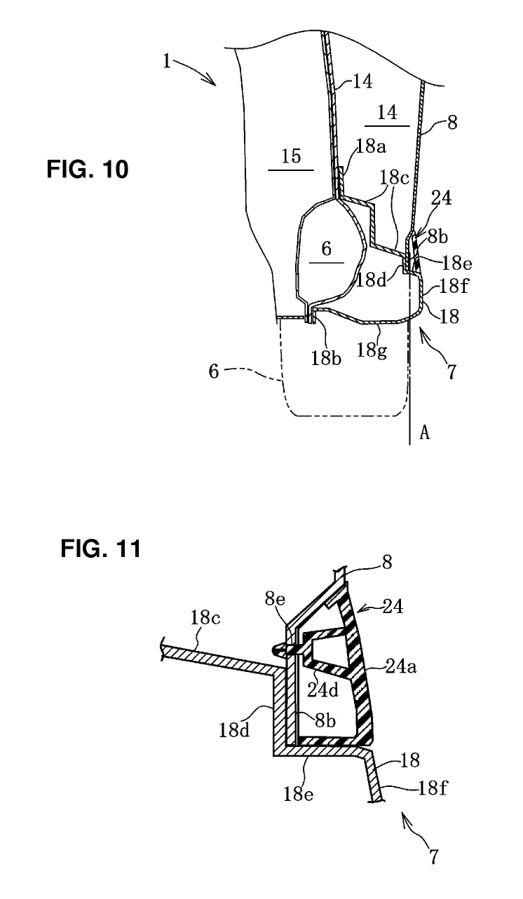

A second embodiment will be described referring to FIGS. 9-11. Herein, the same structures as the first embodiment are denoted by the same reference characters. FIG. 10 is a sectional view of that, which corresponds to FIG. 7 of the first embodiment.

The wheel-house arch portion 8 comprises the wheel house outer 14 which is positioned on the outside and the wheel house inner 15 which is positioned on the inside. The wheel house outer 14 and the wheel house inner 15 are joined at their both ends and upper ends so as to form the space for storing the rear wheel 6 at their central area.

As shown in FIG. 10, the side sill outer 16 and the side sill reinforcement extend rearwardly in the rear area of the vehicle body. The rear end area of the side sill reinforcement 18 contacts the wheel-house arch portion 8, and the second upper flange 18a and the second lower flange 18b contact the outside face of the wheel house outer 14, respectively, which are joined to the wheel house inner 15.

The lower end portion 8b of the wheel-house arch portion 8 is configured to have a concave portion which is concaved toward the inside in the vehicle width direction so as to contact the second upper wall portion 18e of the side sill reinforcement 18. The lower end portion 8b contacts the outside of the joint portion 18d and these are welded together.

The second upper wall portion 18c has the two-stage structure with the upper wall and the lower wall so as to enlarge its contact area with the wheel-house arch portion 8. The second closed cross section 20, which is defined by the second upper wall portion 18e and the flat plate portion 18f, in an area of the vehicle rear portion projects toward the outside beyond the boundary A of the outside face of the rear wheel 6.

As shown in FIG. 11, a garnish 24 which is made from resin is provided on the outside of the lower end portion 8b of the wheel-house arch portion 8. The garnish 24 is of a trigonal prism shape, and comprises a first face portion 24a which is positioned on the outside, a second face portion 24b which forms a front end face, a third face portion 24c which forms a rear end face, and an engaging portion 24d which projects toward the inside. The garnish 24 is attached to the vehicle body 1 with the engaging portion 24d engaging with an engagement portion 8e which is formed at the lower end portion 8b of the wheel-house arch portion 8.

The first face portion 24a is flush with the surface of the wheel-house arch portion 8 at its upper portion, and extends downwardly. Its lower end is flush with the flat plate portion 18f.

Hereinafter, the operations and advantages of the side vehicle-body structure according to the second embodiment will be described.

Like the first embodiment, since the second closed cross section 20 is formed at the side sill reinforcement member 18 and protrudes toward the outside in the vehicle width direction from the outside boundary A, and the resistance of chipping caused by sands, stones or the like during the vehicle traveling can be improved.

Further, since the second closed cross section 20 projects toward the outside from the outside boundary A and the garnish 24 may be arranged above the second closed cross section 20 so as to project outwardly as well, the aerodynamic characteristics can be improved by reducing the amount of traveling winds flowing into the wheel house. Moreover, since the shape of the garnish 24 may be changed, the joint face portion of the side sill outer 16 and the split line can be covered with the garnish 24 regardless of the design of the wheel-house arch portion 8, so that the exterior appearance can be improved.

### Embodiment 3

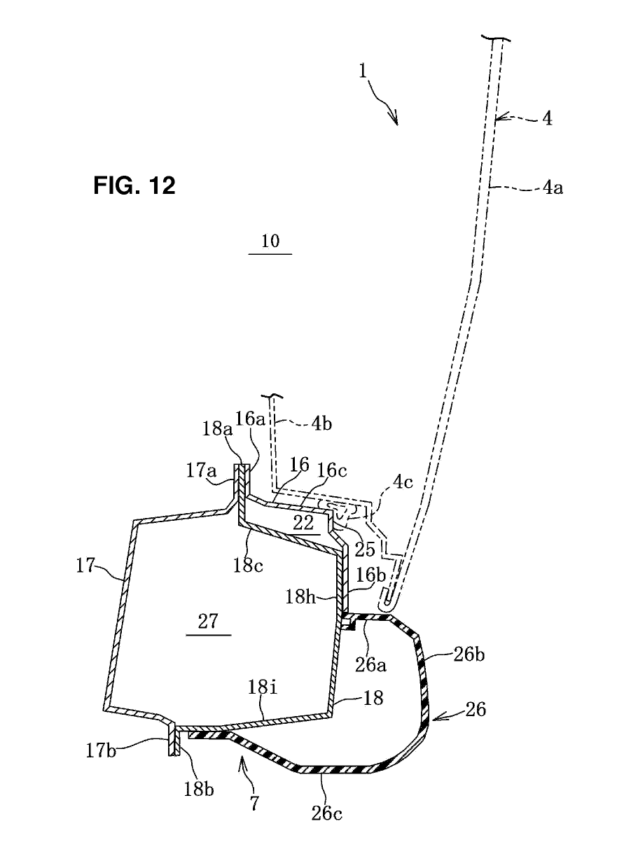

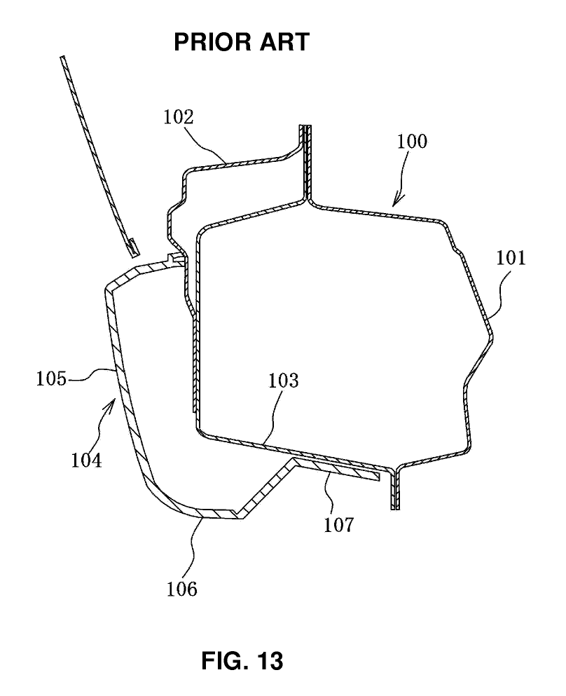

A third embodiment will be described referring to FIG. 12. Herein, the same structures as the first embodiment are denoted by the same reference characters. FIG. 12 is a sectional view of that, which corresponds to FIG. 6 of the first embodiment.

The side sill 7 which is connected to the side frame outer 2 comprises the side sill outer 16 which is formed by the lower portion of the side frame outer 2, the side sill inner 17 which is positioned on the inside of the side sill outer 16, and the side sill reinforcement 18. A side sill garnish 26 which is made from resin is attached to an outside face of the side sill reinforcement 18.

The hat-shaped side sill reinforcement 18 is arranged between the inside hat-shaped shaped side sill inner 17 and the outside side sill outer 16, and the first upper flange 17a and the first lower flange 17b of the side sill inner 17 are welded to the second upper flange 18a and the second lower flange 18b of the side sill reinforcement 18, respectively.

The cross section of the side sill reinforcement 18 is comprised of a first upper wall portion 18c which extends toward the outside continuously from the lower end of the second upper flange 18a, a flat-shaped side wall portion 18h which extends downwardly continuously from the outside end of the first upper wall portion 18c, and a lower wall portion 18i which extends toward the inside from a lower end of he side wall portion 18h and connects to the upper end of the second lower flange 18b. Herein, the first upper wall portion 18c, the side wall portion 18h, and the lower wall portion 18i form respective faces which extend in the vehicle longitudinal direction. The side sill reinforcement 18 and the side sill inner 17 form a fifth closed cross section 27 which extends in the vehicle longitudinal direction.

The rear opening 10 is formed at the rear side of the vehicle body behind the center pillar 13. The first upper flange 17a, the second upper flange 18a and the third upper flange 16a which forms the edge of the rear opening 10 above the third lower flange 16b of the side sill outer 16 are welded together. The projection portion 16c which extends toward the outside continuously from the lower end of the third upper flange 16a is arranged facing to the first upper wall portion 18c and forms the fourth closed cross section 22 together with the first upper wall portion 18c. The third lower flange 16b extends downwardly from the outside end of the projection portion 16c.

The third lower flange 16b extends downwardly toward the central portion of the flat-shaped side wall portion 18h and contacts and is welded to the outside face of the side wall portion 18d.

The side sill garnish 26 comprises an upper wall portion 26a which extends toward the outside beyond the lower end of the rear door 4, a flat-shaped side wall portion 26b which extends downwardly continuously from the upper wall portion 26a, and a lower wall portion 26c which projects downwardly from a lower end portion of the side wall portion 26b and the lower end portion 18b of the second lower flange 18b and extends to the second lower flange 18b. The side sill garnish 26 is attached to a front end, a central portion and a rear end of the vehicle body via screws or the like, respectively.

The upper wall portion 26a contacts the surface of the side wall portion 18h at its inside end and contacts the lower cross section of the third lower flange 16b of the side sill outer 16. The lower wall portion 26c contacts the lower face of the lower wall portion 18i at its upper face on its inside portion. In the present embodiment, the side sill garnish 26 corresponds to the projection portion of the present invention.

Hereinafter, the operations and advantages of the side vehicle-body structure according to the third embodiment will be described.

Like the first embodiment, since the side sill garnish 26 projects toward the outside in the vehicle width direction beyond the lower end portion of the rear door 4, the resistance of chipping caused by sands, stones or the like during the vehicle traveling can be improved.

Since the upper wall portion 26a contacts the lower cross section of the third lower flange 16b of the side sill outer 16, the lower cross section of the third flange 16b can be made be recognized as one body with the side sill garnish 26.

Moreover, since the side sill garnish 26 is formed so as to project toward the outside in front of the rear wheel 6, the aerodynamic characteristics can be improved by reducing the amount of the traveling air flowing into the wheel house. Further, since the shape of the side sill garnish 26 is changed properly, the flexibility of designing can be increased.

Hereinafter, alternatives which are partially modified from the above-described embodiments will be described.

1] While the example in which the side frame outer and the side sill outer are formed integrally was described in the above-described embodiments, the preset invention is applicable to another case in which they are formed separately, which performs the similar advantages.

2] While the example in which the third lower flange of the side sill outer extends downwardly and contacts the projection portion was described in the above-described embodiments, the preset invention is applicable another case in which there exists a small gap formed between the lower cross section (split line) and the projection portion, or the third lower flange extends downwardly obliquely with a specified slant angle, as long as at least the lower cross section (split line) of the third lower flange can be made be recognized as one body with the projection portion, which performs the similar advantages.

3] Any other modifications and improvements may be applied within the scope of a sprit of the present invention.

What is claimed is:

1. A side vehicle-body structure of an automotive vehicle, comprising:
a side body outer panel forming a surface of a vehicle-body side portion; and
a side sill extending in a vehicle longitudinal direction and connected to said side body outer panel,
wherein said side sill includes a side sill outer which is provided at a lower portion of said side body outer panel, a side sill inner which is provided on the inside of the side sill outer in a vehicle width direction, a plate-shaped reinforcement member which is provided between the side sill inner and the side sill outer and joined to a joint face portion of the side sill outer, and a projection portion which projects toward the outside in the vehicle width direction from said joint face portion, and
an upper wall portion of said projection portion is arranged substantially at the same level as a lower end of said joint face portion.

2. The side vehicle-body structure of an automotive vehicle of claim 1, wherein a side door which opens or closes an opening formed at said side body outer panel is provided, and said lower end of the joint face portion of the side sill outer and a lower end portion of the side door are arranged substantially at the same level.

3. The side vehicle-body structure of an automotive vehicle of claim 2, wherein said side door has a seal member which seals a space between the side door and said side sill when the side door closes, and said side sill outer includes a seal face portion which an upper portion of said seal member contacts.

4. The side vehicle-body structure of an automotive vehicle of claim 2, wherein said side body outer panel includes a wheel house portion which stores a rear wheel at a rear portion thereof and a wheel-house arch portion which forms a substantially continuous surface with the closing side door between said wheel house portion and the side door, and a lower end portion of the wheel-house arch portion is arranged substantially at the same level as said lower end of the joint face portion.

5. The side vehicle-body structure of an automotive vehicle of claim 4, wherein a garnish is provided so as to cover said lower end portion of the wheel-house arch portion and said upper wall portion of the projection portion in an area adjacent to said wheel-house arch portion.

6. The side vehicle-body structure of an automotive vehicle of claim 4, wherein said projection portion projects toward the outside from an outside boundary face of the rear wheel.

7. The side vehicle-body structure of an automotive vehicle of claim 2, wherein said projection portion is formed at said plate-shaped reinforcement member and comprised of a protrusion portion which protrudes toward the outside in the vehicle width direction from said joint face portion.

8. The side vehicle-body structure of an automotive vehicle of claim 7, wherein said protrusion portion protrudes toward the outside in the vehicle width direction from the lower end of the side door when the side door closes.

9. The side vehicle-body structure of an automotive vehicle of claim 7, wherein said side sill comprises a flange which comprises a lower end portion of the side sill inner and a lower end portion of said plate-shaped reinforcement member, and said protrusion portion comprises a step portion which projects downwardly beyond said flange.

10. The side vehicle-body structure of an automotive vehicle of claim 7, wherein said protrusion portion comprises a flat plate portion which extends downwardly on the outside.

11. The side vehicle-body structure of an automotive vehicle of claim 10, wherein said side body outer panel includes a wheel house portion which stores a rear wheel at a rear portion thereof and a wheel-house arch portion which forms a substantially continuous surface with the closing side door between said wheel house portion and the side door, a garnish is provided so as to cover a lower end portion of said wheel-house arch portion and said upper wall portion of the projection portion in an area adjacent to said wheel-house arch portion, and said garnish comprises a garnish face portion which is substantially flush with a surface of the wheel-house arch portion and said flat plate portion of the protrusion portion.

12. The side vehicle-body structure of an automotive vehicle of claim 1, wherein said projection portion is comprised of a side sill garnish which is attached to an outside face of said side sill.

13. The side vehicle-body structure of an automotive vehicle of claim 1, wherein said side sill outer is formed integrally with said side body outer panel.
